(19) United States
(12) Patent Application Publication
(10) Pub. No.: US 2023/0282948 A1
(43) Pub. Date: Sep. 7, 2023

(54) Bus-Bar Connection Structure

(71) Applicant: Prime Planet Energy & Solutions, Inc., Tokyo (JP)

(72) Inventors: Naotake YOSHIDA, Himeji-shi (JP); Takashi INAMURA, Himeji-shi (JP)

(21) Appl. No.: 18/178,515

(22) Filed: Mar. 5, 2023

(30) Foreign Application Priority Data
Mar. 7, 2022 (JP) 2022-034237

(51) Int. Cl. H01M 50/516; H01M 50/507; H01M 50/566

(52) U.S. Cl. CPC H01M 50/516; H01M 50/507; H01M 50/566; H01M 50/103

(57) ABSTRACT

A bus-bar connection structure includes: a terminal portion having a first facing surface; a bus bar having a second facing surface that faces the first facing surface with a clearance being provided between the second facing surface and the first facing surface in a predetermined direction; and a weld portion that connects the terminal portion and the bus bar. The weld portion has: a first weld layer provided in the bus bar; a second weld layer provided in the terminal portion; and an intermediate weld layer disposed in the clearance, the intermediate weld layer connecting the first weld layer and the second weld layer. The weld portion has a cross sectional shape in which a minimum width of the intermediate weld layer in a direction orthogonal to the predetermined direction is larger than a minimum width of the first weld layer in the direction orthogonal to the predetermined direction.

This nonprovisional application is based on Japanese Patent Application No. 2022-034237 filed on Mar. 7, 2022 with the Japan Patent Office, the entire contents of which are hereby incorporated by reference.

### BACKGROUND OF THE INVENTION

### Field of the Invention

The present invention relates to a bus-bar connection structure.

### Description of the Background Art

For example, Japanese Patent Laying-Open No. 2015-11785 discloses a battery module including: a plurality of battery cells; and a plurality of bus bars for electrically connecting the plurality of battery cells. Each of the bus bars is laid on an external terminal of a battery cell with a clearance having a size of more than or equal to 10 μm and less than 50 μm being provided therebetween. A weld portion that connects the external terminal and the bus bar is provided in the battery module by laser welding. The cross sectional shape of the weld portion is an inverted triangular shape or an inverted trapezoidal shape.

### SUMMARY OF THE INVENTION

When excessive external force is applied to the weld portion that connects the bus bar to the external terminal, the weld portion may be broken to compromise a connection state between the bus bar and the external terminal. Therefore, further improvement has been required for such a bus-bar connection structure.

Thus, it is an object of the present invention to solve the above-described problem and to provide a bus-bar connection structure by which connection strength between a bus bar and a terminal portion can be increased.

A bus-bar connection structure according to the present invention includes: a terminal portion having a first facing surface; a bus bar having a second facing surface that faces the first facing surface with a clearance being provided between the second facing surface and the first facing surface in a predetermined direction, the bus bar being laid on the terminal portion; and a weld portion that connects the terminal portion and the bus bar. The weld portion has: a first weld layer provided in the bus bar, the first weld layer extending to the second facing surface through the bus bar in the predetermined direction; a second weld layer provided in the terminal portion, the second weld layer extending from the first facing surface in the predetermined direction; and an intermediate weld layer disposed in the clearance, the intermediate weld layer connecting the first weld layer and the second weld layer. When the weld portion is cut along a plane parallel to the predetermined direction, the weld portion has a cross sectional shape in which a minimum width of the intermediate weld layer in a direction orthogonal to the predetermined direction is larger than a minimum width of the first weld layer in the direction orthogonal to the predetermined direction.

According to the bus-bar connection structure thus configured, since the weld portion has the cross sectional shape in which the minimum width of the intermediate weld layer is larger than the minimum width of the first weld layer, the strength of the intermediate weld layer disposed in the clearance can be sufficiently secured. Thus, connection strength between the bus bar and the terminal portion can be increased.

Preferably, the bus bar is provided with a recess having a shape recessed in a direction away from the first facing surface in the predetermined direction. The second facing surface is constituted of a bottom surface of the recess.

Preferably, the clearance is constituted of a space that is opened to outside. According to the bus-bar connection structure thus configured, when a molten metal of the bus bar enters the clearance during welding of the bus bar and the terminal portion, air can flow out from the clearance to the outside. Thus, the weld portion having the cross sectional shape in which the minimum width of the intermediate weld layer is larger than the minimum width of the first weld layer can be readily obtained.

Preferably, when viewed in the predetermined direction, the weld portion extends in an annular shape. The bus bar is provided with a through hole that extends through the bus bar in the predetermined direction and that is opened to the second facing surface on an inner side with respect to the weld portion extending in the annular shape.

According to the bus-bar connection structure thus configured, the through hole can be a path for air flowing out from the clearance during welding of the bus bar and the terminal portion.

Preferably, when viewed in the predetermined direction, the weld portion has a circular ring shape. The through hole extends on a central axis of the circular ring shape.

According to the bus-bar connection structure thus configured, a positional relation of each portion of the weld portion with respect to the through hole is uniform in a circumferential direction of the weld portion having the circular ring shape. Thus, the intermediate weld layer can have a cross sectional shape with no variation in the circumferential direction of the weld portion.

On the other hand, when viewed in the predetermined direction, the weld portion may have a shape in which a portion of the annular shape is disconnected (for example, a C shape or a U shape), or may have a straight shape or a curved shape. By appropriately selecting the shape of the weld portion, welding corresponding to an area of a region that can be welded can be attained.

Preferably, when the weld portion is cut along a plane parallel to the predetermined direction, the weld portion has a cross sectional shape in which a width of the weld portion in the direction orthogonal to the predetermined direction is maximum at a position of a boundary between the first weld layer and the intermediate weld layer.

According to the bus-bar connection structure thus configured, the strength of the weld portion at the boundary between the first weld layer and the intermediate weld layer can be sufficiently secured, thereby further increasing the connection strength between the bus bar and the terminal portion.

Preferably, a size of the clearance in the predetermined direction is more than or equal to 0.01 mm. According to the bus-bar connection structure thus configured, a space via which the molten metal of the bus bar enters the clearance can be sufficiently secured during welding of the bus bar and the terminal portion. Thus, the weld portion having the cross sectional shape in which the minimum width of the intermediate weld layer is larger than the minimum width of the first weld layer can be readily obtained.

Preferably, a size of the clearance in the predetermined direction is less than or equal to a thickness of the bus bar in the predetermined direction.

According to the bus-bar connection structure thus configured, there can be suppressed such a phenomenon that connection between the first weld layer and the second weld layer by the intermediate weld layer cannot be obtained because the molten metal of the bus bar having entered the clearance is not held between the first facing surface and the second facing surface during welding of the bus bar and the terminal portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded assembly diagram showing a battery pack to which a bus-bar connection structure according to an embodiment of the present invention is applied.

FIG. 2 is a perspective view showing a battery cell included in the battery pack in FIG. 1.

FIG. 3 is a perspective view showing a bus bar.

FIG. 4 is another perspective view showing the bus bar.

FIG. 5 is a top view showing the bus-bar connection structure.

FIG. 6 is a cross sectional view showing the bus-bar connection structure when viewed in a direction along a line VI-VI in FIG. 5.

FIG. 7 is a cross sectional view showing the bus-bar connection structure in a range surrounded by a chain double-dashed line VII in FIG. 6.

FIG. 8 is a cross sectional view showing a step of welding the bus bar to a terminal portion in an example of the present disclosure.

FIG. 9 is a schematic diagram showing a cross sectional shape of a weld portion in the example of the present disclosure.

FIG. 10 is a schematic diagram showing a cross sectional shape of a weld portion in a comparative example.

FIG. 11 is another schematic diagram showing the cross sectional shape of the weld portion in the comparative example.

FIG. 12 is a cross sectional view showing a first modification of the bus-bar connection structure in FIG. 6.

FIG. 13 is a cross sectional view showing a second modification of the bus-bar connection structure in FIG. 6.

FIG. 14 is a perspective view showing a first modification of the bus bar in FIGS. 3 and 4.

FIG. 15 is a perspective view showing a second modification of the bus bar in FIGS. 3 and 4.

### DESCRIPTION OF THE PREFERRED EMBODIMENTS

Embodiments of the present invention will be described with reference to figures. It should be noted that in the figures referred to below, the same or corresponding members are denoted by the same reference characters.

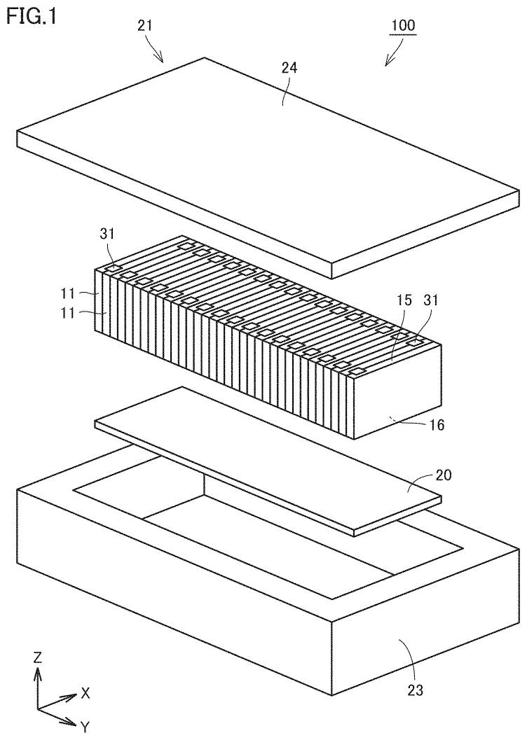

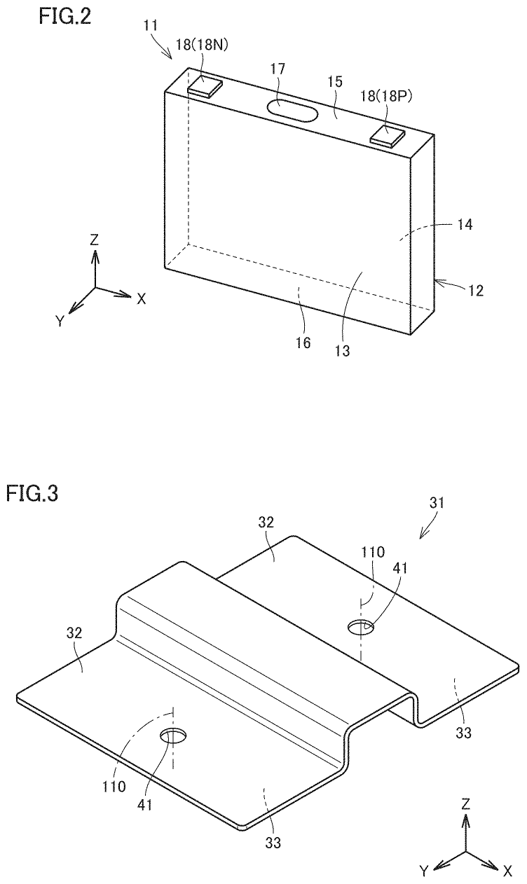

FIG. 1 is an exploded assembly diagram showing a battery pack to which a bus-bar connection structure according to an embodiment of the present invention is applied. FIG. 2 is a perspective view showing a battery cell included in the battery pack in FIG. 1.

Referring to FIGS. 1 and 2, a battery pack 100 is used as a power supply for driving a vehicle such as a hybrid electric vehicle (HEY), a plug-in hybrid electric vehicle (PHEV), or a battery electric vehicle (BEV).

In the present specification, for convenience of explanation of a structure of battery pack 100, a “Y axis” represents an axis extending in a stacking direction of a plurality of below-described battery cells 11 and in a horizontal direction, an “X axis” represents an axis extending in a direction orthogonal to the Y axis and in the horizontal direction, and a “Z axis” represents an axis extending in an upward/downward direction.

First, an overall structure of battery pack 100 will be described. Battery pack 100 has a plurality of battery cells 11 and a case body 21. The plurality of battery cells 11 are stacked in the Y axis direction. Case body 21 accommodates the plurality of battery cells 11. Case body 21 has a case main body 23 and a case top portion 24. Case main body 23 is constituted of a box body that has an external appearance with a rectangular parallelepiped shape and that is opened upward. Case top portion 24 is constituted of a cover body that is detachably attached to the opening of case main body 23.

As shown in FIG. 2, each of battery cells 11 is a lithium ion battery. Battery cell 11 has a prismatic shape and has a thin plate shape in the form of a rectangular parallelepiped. The plurality of battery cells 11 are stacked such that the Y axis direction corresponds to the thickness direction of each battery cell 11.

Each of battery cells 11 has an exterior package 12. Exterior package 12 is constituted of a housing having a rectangular parallelepiped shape, and forms the external appearance of battery cell 11. An electrode assembly and an electrolyte solution are accommodated in exterior package 12.

Exterior package 12 has a first side surface 13, a second side surface 14, a top surface 15, and a bottom surface 16. Each of first side surface 13 and second side surface 14 is constituted of a flat surface orthogonal to the Y axis. First side surface 13 and second side surface 14 are oriented oppositely in the Y axis direction. Each of first side surface 13 and second side surface 14 has the largest area among the areas of the plurality of side surfaces of exterior package 12.

Each of top surface 15 and bottom surface 16 is constituted of a flat surface orthogonal to the Z axis. Top surface 15 is oriented upward. Bottom surface 16 is oriented downward. Bottom surface 16 is fixed to an inner bottom surface of case body 21 (case main body 23) using an adhesive agent 20. Top surface 15 is provided with a gas-discharge valve 17 for discharging gas generated in exterior package 12 to outside of exterior package 12 when internal pressure of exterior package 12 becomes equal to or more than a predetermined value due to the gas.

Battery cell 11 further has a terminal portion 18 including a pair of a positive electrode terminal 18P and a negative electrode terminal 18N. Terminal portion 18 is composed of a metal. Terminal portion 18 is provided on top surface 15. Positive electrode terminal 18P and negative electrode terminal 18N are provided to be separated from each other in the X axis direction. Positive electrode terminal 18P and negative electrode terminal 18N are provided on both sides beside gas-discharge valve 17 in the X axis direction.

The plurality of battery cells 11 are stacked such that first side surfaces 13 of battery cells 11, 11 adjacent to each other in the Y axis direction face each other and second side surfaces 14 of battery cells 11, 11 adjacent to each other in the Y axis direction face each other. Thus, positive electrode terminals 18P and negative electrode terminals 18N are alternately arranged in the Y axis direction in which the plurality of battery cells 11 are stacked.

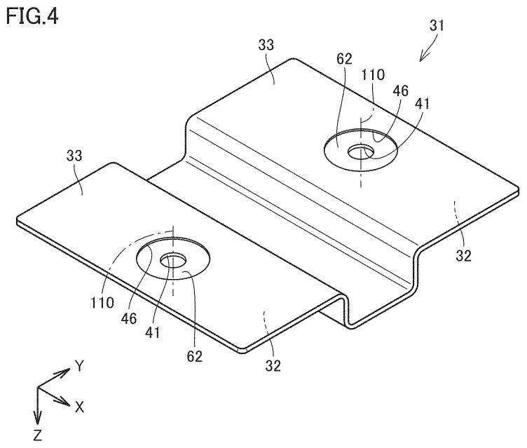

Each of FIGS. 3 and 4 is a perspective view showing a bus bar. Referring to FIGS. 1 to 4, battery pack 100 further has a plurality of bus bars 31. Each of bus bars 31 is composed of a metal. Between battery cells 11, 11 adjacent to each other in the Y axis direction, positive electrode terminal 18P and negative electrode terminal 18N arranged side by side in the Y axis direction are connected to each other by bus bar 31. Thus, the plurality of battery cells 11 are electrically connected together in series. It should be noted that the plurality of battery cells 11 may be electrically connected together in parallel or in series and parallel in combination.

Bus bar 31 is constituted of a plate material having a first main surface 32 and a second main surface 33. Each of first main surface 32 and second main surface 33 is constituted of a flat surface parallel to the Z axis. Second main surface 33 is disposed on the rear side with respect to first main surface 32.

Bus bar 31 is provided with through holes 41 and recesses 46. Each of through holes 41 extends through bus bar 31 in the Z axis direction. Through hole 41 extends on a central axis 110 parallel to the Z axis direction. Through hole 41 forms a circular opening centered on central axis 110. Each of recesses 46 has a recess shape recessed in the Z axis direction from second main surface 33. Recess 46 is provided on central axis 110. Recess 46 has a circular shape centered on central axis 110, and forms, in second main surface 33, an opening having a diameter larger than that of through hole 41.

Bus bar 31 has a second facing surface 62. Second facing surface 62 is constituted of a flat surface orthogonal to the Z axis. In the present embodiment, second facing surface 62 is constituted of the bottom surface of recess 46. Second facing surface 62 has a circular ring shape centered on central axis 110. Through hole 41 is opened inside second facing surface 62 having the ring shape.

In bus bar 31, respective pairs of through holes 41 and recesses 46 are formed at two positions connected to terminal portions 18 of battery cells 11, 11 adjacent to each other in the Y axis direction.

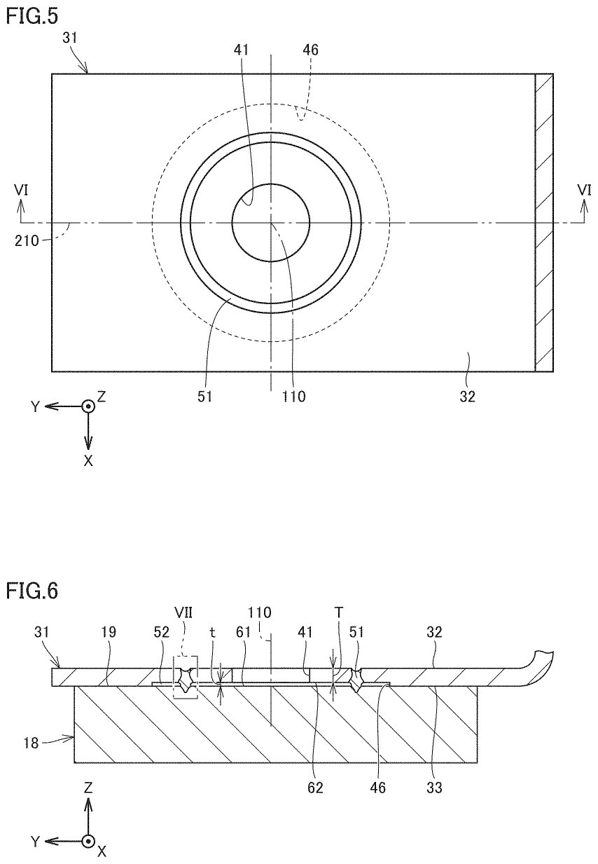

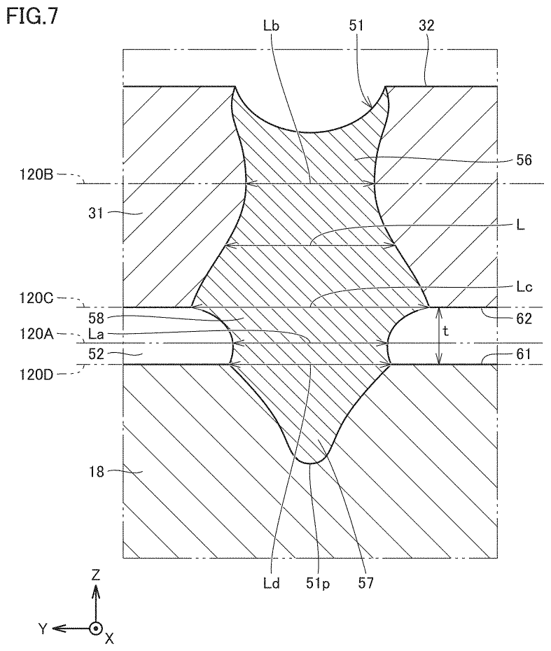

Next, a structure for connection of bus bar 31 to terminal portion 18 will be described. FIG. 5 is a top view showing the bus-bar connection structure. FIG. 6 is a cross sectional view showing the bus-bar connection structure when viewed in a direction along a line VI-VI in FIG. 5. FIG. 7 is a cross sectional view showing the bus-bar connection structure in a range surrounded by a chain double-dashed line VII in FIG. 6.

Referring to FIGS. 5 to 7, bus bar 31 is laid on terminal portion 18 in the Z axis direction. Terminal portion 18 has a top surface 19. Top surface 19 is constituted of a flat surface orthogonal to the Z axis direction. Top surface 19 is in surface contact with second main surface 33 of bus bar 31.

Terminal portion 18 has a first facing surface 61. First facing surface 61 is constituted of a flat surface orthogonal to the Z axis direction. In the present embodiment, first facing surface 61 is a portion of top surface 19. Second facing surface 62 of bus bar 31 faces first facing surface 61 with a clearance 52 being provided between second facing surface 62 and first facing surface 61 in the Z axis direction. In the present embodiment, the Z axis direction, which is a direction in which first facing surface 61 and second facing surface 62 face each other, corresponds to a “predetermined direction” in the present invention.

A size t of clearance 52 in the Z axis direction is preferably more than or equal to 0.01 mm (0.01 mm≤t). Size t of clearance 52 in the Z axis direction may be more than or equal to 0.05 mm (0.05 mm≤t), more than or equal to 0.1 mm (0.1 mm≤t), or more than or equal to 0.3 mm (0.3 mm≤t). Size t of clearance 52 in the Z axis direction is preferably less than or equal to a thickness T of bus bar 31 in the Z axis direction at a position at which a below-described weld portion 51 is provided (t≤T).

Clearance 52 is constituted of a space that is opened to outside. Clearance 52 is opened to a space around terminal portion 18 and bus bar 31 (space in case body 21 in FIG. 1) via through hole 41. Since recess 46 is recessed from second main surface 33 in a direction away from first facing surface 61 in the Z axis direction, clearance 52 is formed between first facing surface 61 and second facing surface 62.

Battery pack 100 further has weld portions 51. Each of weld portion 51 connects terminal portion 18 and bus bar 31. Weld portion 51 is configured to connect terminal portion 18 and bus bar 31 using welding such as laser welding. Weld portion 51 is a portion formed as follows: during the welding, bus bar 31 and terminal portion 18 are melted in this order and then molten metals of bus bar 31 and terminal portion 18 are solidified to be in one piece.

Weld portion 51 is provided at a position overlapping with clearance 52 when viewed in the Z axis direction. Weld portion 51 is exposed at first main surface 32, and extends from first main surface 32 in the Z axis direction so as to be separated away from first main surface 32. Weld portion 51 extends through bus bar 31 in the Z axis direction and extends into terminal portion 18 via clearance 52, and has a tip portion 51p inside terminal portion 18. The Z axis direction corresponds to a depth direction of weld portion 51. When viewed in the Z axis direction, weld portion 51 extends in an annular shape. Weld portion 51 has a circular ring shape centered on central axis 110. Through hole 41 is opened to second facing surface 62 on the inner side with respect to weld portion 51 extending in the annular shape.

As shown in FIG. 7, weld portion 51 has a first weld layer 56, a second weld layer 57, and an intermediate weld layer 58. First weld layer 56, second weld layer 57, and intermediate weld layer 58 are contiguous to one another in the Z axis direction so as to form weld portion 51.

First weld layer 56 is provided in bus bar 31. First weld layer 56 extends from first main surface 32 toward second facing surface 62 in the Z axis direction. First weld layer 56 extends to second facing surface 62 through bus bar 31 in the Z axis direction. Second weld layer 57 is provided in terminal portion 18. Second weld layer 57 extends from first facing surface 61 in the Z axis direction. Second weld layer 57 forms a tip portion 51p of weld portion 51 inside terminal portion 18. Intermediate weld layer 58 is disposed in clearance 52. Intermediate weld layer 58 extends from second facing surface 62 toward first facing surface 61 in the Z axis direction. Intermediate weld layer 58 connects first weld layer 56 and second weld layer 57.

When weld portion 51 is cut along a plane 210 parallel to the Z axis direction, weld portion 51 has a cross sectional shape in which a minimum width La of intermediate weld layer 58 in a direction orthogonal to the Z axis direction is larger than a minimum width Lb of first weld layer 56 in the direction orthogonal to the Z axis direction (La>Lb).

Plane 210 includes central axis 110 of weld portion 51 having a ring shape and extends from central axis 110 outward in the radial direction. Plane 210 is a plane orthogonal to a direction in which weld portion 51 extends (tangential direction of a circle centered on central axis 110) when viewed in the Z axis direction. Plane 210 is a plane orthogonal to a scanning direction of a laser head 71 described later. FIG. 5 representatively shows a case where plane 210 is a Y-Z axes plane. It should be noted that when laser processing by laser head 71 is performed onto a spot (fixed point) on the surface of bus bar 31, plane 210 may be a plane including the central axis of weld portion 51 extending in the Z axis direction.

FIG. 7 shows: a first depth position 120B located between first main surface 32 and second facing surface 62 in the Z axis direction; a second depth position 120C located at second facing surface 62 (boundary between first weld layer 56 and intermediate weld layer 58) in the Z axis direction; a third depth position 120A located between second facing surface 62 and first facing surface 61 in the Z axis direction; and a fourth depth position 120D located at the first facing surface 61 (boundary between intermediate weld layer 58 and second weld layer 57) in the Z axis direction.

A width L of weld portion 51 (first weld layer 56, intermediate weld layer 58, and second weld layer 57) in the direction (Y axis direction) orthogonal to the Z axis direction is varied depending on a position in the Z axis direction. In general, width L of first weld layer 56 is decreased in a direction from first main surface 32 toward first depth position 120B, and becomes a minimum width Lb at first depth position 120B. Width L of first weld layer 56 is increased in a direction from first depth position 120B toward second depth position 120C, and becomes a maximum width Lc at second depth position 120C. Width L of intermediate weld layer 58 becomes maximum width Lc at second depth position 120C, is decreased in a direction from second depth position 120C toward third depth position 120A, and becomes a minimum width La at third depth position 120A. Width L of intermediate weld layer 58 is increased in a direction from third depth position 120A toward fourth depth position 120D, and becomes a width Ld that is larger than minimum width La and that is smaller than maximum width Lc at fourth depth position 120D. Width L of second weld layer 57 becomes a maximum width Ld at fourth depth position 120D, and is decreased in a direction from fourth depth position 120D toward tip portion 51p.

When weld portion 51 is cut along plane 210 parallel to the Z axis direction, weld portion 51 has a cross sectional shape in which width L of weld portion 51 in the direction orthogonal to the Z axis direction is maximum at the position of the boundary between first weld layer 56 and intermediate weld layer 58. That is, width Lc of weld portion 51 at second depth position 120C is maximum in width L of weld portion 51.

In the present embodiment, since minimum width La of intermediate weld layer 58 is larger than minimum width Lb of first weld layer 56, the strength of intermediate weld layer 58 disposed in clearance 52 can be sufficiently secured. Further, since the width of weld portion 51 is maximum at the position of the boundary between first weld layer 56 and intermediate weld layer 58, weld portion 51 can be effectively prevented from being fractured at the position of the boundary between first weld layer 56 and intermediate weld layer 58. Thus, connection strength between bus bar 31 and terminal portion 18 can be increased.

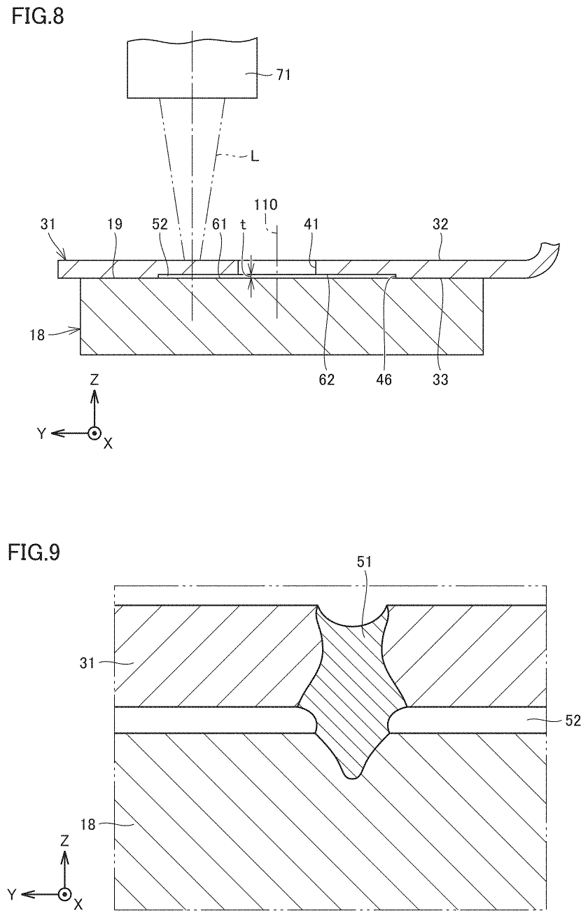

FIG. 8 is a cross sectional view showing a step of welding a bus bar to a terminal portion in an example of the present disclosure. FIG. 9 is a schematic diagram showing a cross sectional shape of a weld portion in the example of the present disclosure. Referring to FIGS. 8 and 9, in the present example, a bus bar 31 composed of aluminum and having a thickness of 0.8 mm and a terminal portion 18 composed of aluminum and having a thickness of 1.8 mm were used, and a size of a clearance 52 in the Z axis direction was set to 0.3 mm. On this occasion, the size of clearance 52 in the Z axis direction was measured via through hole 41.

Bus bar 31 was welded to terminal portion 18 using a fiber laser welding machine. More specifically, a laser head 71 of the fiber laser welding machine was caused to face bus bar 31, and scanning by laser head 71 was performed in a circumferential direction around central axis 110 while emitting laser light L to first main surface 32. An output of laser light L was set to 1000 to 2000 W, a spot diameter of laser light L was set to 0.15 mm, and a scanning speed of laser head 71 was set to 100 to 500 mm/s. As a result, weld portion 51 having the cross sectional shape described with reference to FIG. 7 could be obtained.

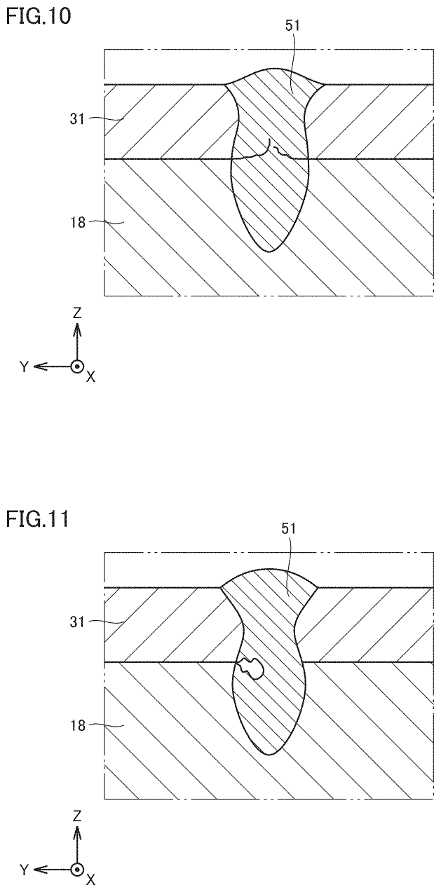

Each of FIGS. 10 and 11 is a schematic diagram showing a cross sectional shape of a weld portion in a comparative example. Referring to FIGS. 10 and 11, in each of these comparative examples, terminal portion 18 and bus bar 31 were laid on each other without providing clearance 52 between bus bar 31 and terminal portion 18, and bus bar 31 was welded to terminal portion 18 in the same manner as in the above example of the present disclosure. As a result, a minute crack was generated in weld portion 51 at the boundary between terminal portion 18 and bus bar 31 as shown in FIG. 10, or a blowhole was formed due to gas failing to be completely released as shown in FIG. 11.

Referring to FIGS. 5 to 7, in the present embodiment, since clearance 52 is provided between first facing surface 61 of terminal portion 18 and second facing surface 62 of bus bar 31, weld portion 51 is provided to have the cross sectional shape in which minimum width La of intermediate weld layer 58 disposed in clearance 52 is larger than minimum width Lb of first weld layer 56 provided in bus bar 31. In this case, when size t of clearance 52 is set to be more than or equal to 0.01 mm, a space via which the molten metal of bus bar 31 enters clearance 52 can be sufficiently secured during welding of bus bar 31 and terminal portion 18. Further, since clearance 52 is opened to the outside via through hole 41, through hole 41 serves as an air path during the welding of bus bar 31 and terminal portion 18, with the result that the molten metal of bus bar 31 is facilitated to enter clearance 52. Thus, weld portion 51 having the cross sectional shape in which minimum width La of intermediate weld layer 58 is larger than minimum width Lb of first weld layer 56 can be readily obtained.

Further, since through hole 41 extends on central axis 110 of weld portion 51 having the circular ring shape when viewed in the Z axis direction, the positional relation of each portion of weld portion 51 with respect to through hole 41 is uniform in the circumferential direction around central axis 110. Thus, intermediate weld layer 58 can have a cross sectional shape with no variation in the circumferential direction around central axis 110.

Further, when clearance 52 is too large, the molten metal of bus bar 31 having entered clearance 52 falls on first facing surface 61, thus presumably resulting in occurrence of such a phenomenon that weld portion 51 is disconnected between bus bar 31 and terminal portion 18. To address this, the size of clearance 52 is made less than or equal to the thickness of bus bar 31, with the result that such a phenomenon can be effectively prevented.

Further, bus bar 31 is provided with recess 46 to provide clearance 52. Since bus bar 31 is thin at the position at which recess 46 is provided, bus bar 31 can be melted with a smaller output of laser light L when welding bus bar 31 and terminal portion 18. Thus, terminal portion 18 can be avoided from being irradiated with laser light L having a high output, thereby appropriately protecting terminal portion 18.

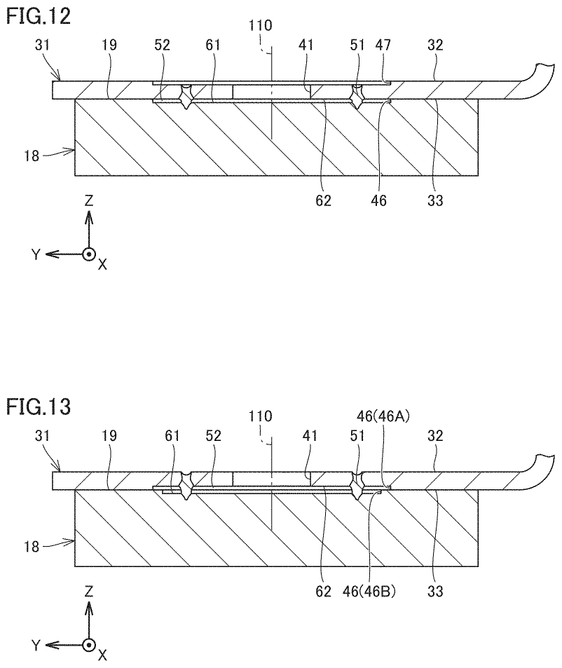

Each of FIGS. 12 and 13 is a cross sectional view showing a modification of the bus-bar connection structure in FIG. 6. Referring to FIG. 12, in the present modification, a recess 46 for providing clearance 52 is provided in terminal portion 18. Recess 46 has a recess shape recessed from top surface 19. Second facing surface 62 is a portion of second main surface 33, and first facing surface 61 is constituted of a bottom surface of recess 46. Bus bar 31 is provided with a recess 47 having a recess shape recessed from first main surface 32. It should be noted that when recess 46 is provided in bus bar 31, processing for providing recess 46 is performed more readily than when recess 46 is provided in terminal portion 18.

Referring to FIG. 13, in the present modification, a first recess 46A is provided in bus bar 31 and a second recess 46B is provided in terminal portion 18 as recess 46 for providing clearance 52. First recess 46A has a recess shape recessed from second main surface 33. Second recess 46B has a recess shape recessed from top surface 19. Second facing surface 62 is constituted of the bottom surface of first recess 46A, and first facing surface 61 is constituted of the bottom surface of second recess 46B.

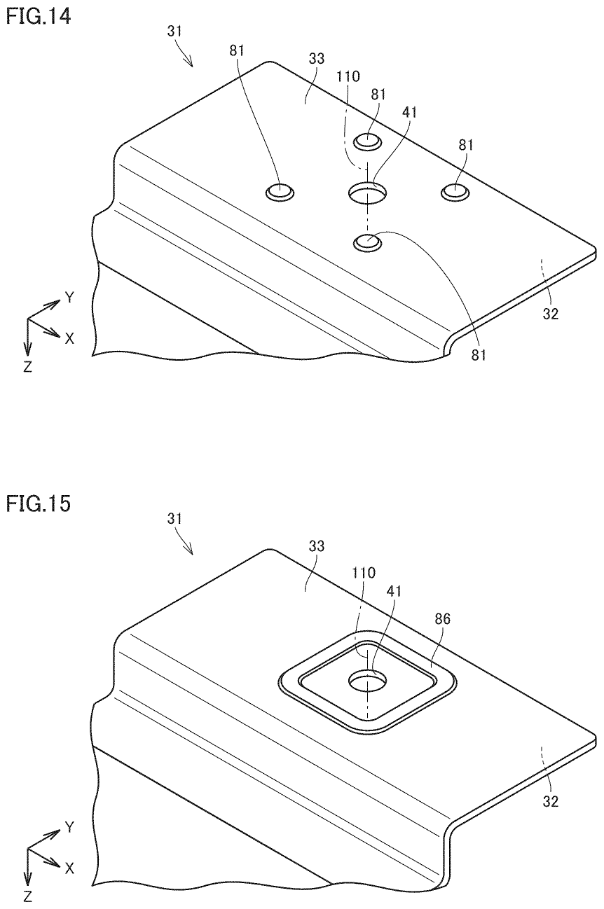

Each of FIGS. 14 and 15 is a perspective view showing a modification of the bus bar in FIGS. 3 and 4. Referring to FIG. 14, in the present modification, bus bar 31 is provided with a plurality of protrusions 81 each for providing clearance 52 instead of recess 46. Each of protrusions 81 protrudes from second main surface 33. The plurality of protrusions 81 are provided around through hole 41 with a space being interposed therebetween. Referring to FIG. 15, in the present modification, bus bar 31 is provided with a protuberance 86 for providing clearance 52 instead of recess 46. Protuberance 86 protrudes from second main surface 33. Protuberance 86 extends in an annular shape around through hole 41.

In these modifications, the tip portion of each protrusion 81 or protuberance 86 is in abutment with top surface 19 of terminal portion 18, thereby providing clearance 52 between bus bar 31 and terminal portion 18.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A bus-bar connection structure comprising:
a terminal portion having a first facing surface;
a bus bar having a second facing surface that faces the first facing surface with a clearance being provided between the second facing surface and the first facing surface in a predetermined direction, the bus bar being laid on the terminal portion; and
a weld portion that connects the terminal portion and the bus bar, wherein
the weld portion has
a first weld layer provided in the bus bar, the first weld layer extending to the second facing surface through the bus bar in the predetermined direction,
a second weld layer provided in the terminal portion, the second weld layer extending from the first facing surface in the predetermined direction, and
an intermediate weld layer disposed in the clearance, the intermediate weld layer connecting the first weld layer and the second weld layer, and
when the weld portion is cut along a plane parallel to the predetermined direction, the weld portion has a cross sectional shape in which a minimum width of the intermediate weld layer in a direction orthogonal to the predetermined direction is larger than a minimum width of the first weld layer in the direction orthogonal to the predetermined direction.

2. The bus-bar connection structure according to claim 1, wherein
the bus bar is provided with a recess having a shape recessed in a direction away from the first facing surface in the predetermined direction, and
the second facing surface is constituted of a bottom surface of the recess.

3. The bus-bar connection structure according to claim 1, wherein the clearance is constituted of a space that is opened to outside.

4. The bus-bar connection structure according to claim 3, wherein
when viewed in the predetermined direction, the weld portion extends in an annular shape, and
the bus bar is provided with a through hole that extends through the bus bar in the predetermined direction and that is opened to the second facing surface on an inner side with respect to the weld portion extending in the annular shape.

5. The bus-bar connection structure according to claim 4, wherein
when viewed in the predetermined direction, the weld portion has a circular ring shape, and
the through hole extends on a central axis of the circular ring shape.

6. The bus-bar connection structure according to claim 1, wherein when the weld portion is cut along a plane parallel to the predetermined direction, the weld portion has a cross sectional shape in which a width of the weld portion in the direction orthogonal to the predetermined direction is maximum at a position of a boundary between the first weld layer and the intermediate weld layer.

7. The bus-bar connection structure according to claim 1, wherein a size of the clearance in the predetermined direction is more than or equal to 0.01 mm.

8. The bus-bar connection structure according to claim 1, wherein a size of the clearance in the predetermined direction is less than or equal to a thickness of the bus bar in the predetermined direction.
